(19) United States
(12) Patent Application Publication
(10) Pub. No.: US 2026/0138571 A1
(43) Pub. Date: May 21, 2026

(54) System and Method for Controlling Service Braking in a Combination Vehicle Based on Vehicle Stability

(71) Applicant: KB Intellectual Property GmbH & Co., KG, Pullach (DE)

(72) Inventors: Phillip J. Kasper, Elyria, OH (US); Andrew J. Pilkington, Avon Oak, OH (US); Daniel P. Zula, North Ridgeville, OH (US)

(21) Appl. No.: 18/953,719

(22) Filed: Nov. 20, 2024

(51) Int. Cl. B60T 7/20; B60T 8/17; B60T 8/171; B60T 8/172

(52) U.S. Cl. CPC B60T 7/20; B60T 8/1708; B60T 8/171; B60T 8/172; B60T 2201/03; B60T 2250/00

(57) ABSTRACT

A system for controlling service braking in a combination vehicle includes a controller that receives an object detection signal from a sensor supported on a towing member of the vehicle. The sensor has a field of view encompassing an area on a lateral side of the vehicle and the signal includes information regarding the location of a towed member of the vehicle relative to the location of the towing member. The controller determines, responsive to the object detection signal, whether the location of the towed member relative to a location of the towing member of the vehicle meets a predetermined condition. Following this determination, the controller transmits either a first control signal or a second control signal if the vehicle, the first and second control signals having different characteristics.

### BACKGROUND OF THE INVENTION

### a. Field of the Invention

This disclosure relates to a system and method for controlling service braking in a combination vehicle. In particular, this disclosure relates to a system and method that adjust service braking performed in response to requests from advanced drive assistance systems (i.e., automated emergency braking events) on the combination vehicle based on the stability of the combination vehicle.

### b. Background Art

Modern combination vehicles, (i.e., vehicles including a towing member or power unit and one more towed members) often contain a variety of advanced drive assistance systems (ADAS) including, for example, collision warning systems, blind-spot warning systems, lane departure warning systems, cross traffic warning systems, automated emergency braking (AEB) systems, anti-lock braking (ABS) systems, collision avoidance systems, adaptive cruise control systems, traction control systems, stability control systems, lane keep assist systems or lane centering systems and parking assist systems. A number of these ADAS systems are configured to control the vehicle's braking system to slow or halt movement of the vehicle and to, for example, prevent potential collisions between the vehicle and other vehicles, pedestrians or road infrastructure. Although brake actuation by these systems may effectively prevent, or at least limit, potential collisions, brake actuation may also have a negative impact on the stability of the combination vehicle. Combination vehicles suffer from significant instability due to their size, weight (and weight distribution), and the pivoting connections between members of the combination vehicles that allow for maneuverability of the vehicle. Brake actuation by an ADAS system during a time when the vehicle is unstable may create a safety risk for the vehicle operator and other individuals near the vehicle as well as a risk of damage to the vehicle, other vehicles and road infrastructure.

The inventors herein have recognized a need for a system and method for controlling service braking in a combination vehicle that will minimize and/or eliminate one or more of the above-identified deficiencies.

### BRIEF SUMMARY OF THE INVENTION

This disclosure relates to a system and method for controlling service braking in a combination vehicle. In particular, this disclosure relates to a system and method that adjust service braking performed in response to requests from advanced drive assistance systems (i.e., automated emergency braking events) on the combination vehicle based on the stability of the combination vehicle.

An embodiment of a system for controlling service braking in a combination vehicle includes a controller configured to receive an object detection signal from a sensor supported on a towing member of the combination vehicle. The sensor has a field of view encompassing an area on a lateral side of the combination vehicle and the object detection signal includes information regarding a location of a towed member of the combination vehicle relative to a location of the towing member of the combination vehicle. The controller is further configured to determine, responsive to the object detection signal, whether the location of the towed member of the combination vehicle relative to a location of the towing member of the combination vehicle meets a predetermined condition. The controller is further configured to transmit a first control signal if the location of the towed member of the combination vehicle relative to the location of the towing member of the combination vehicle meets the predetermined condition. The first control signal is configured to cause delivery of a first fluid pressure having a first characteristic for use in actuating a service brake on the combination vehicle. The controller is further configured to transmit a second control signal if the location of the towed member of the combination vehicle relative to the location of the towing member of the combination vehicle does not meet the predetermined condition. The second control signal is configured to cause delivery of a second fluid pressure having a second characteristic different than the first characteristic for use in actuating the service brake.

An embodiment of an article of manufacture includes a non-transitory computer storage medium having a computer program encoded thereon that, when executed by a controller on a combination vehicle, controls service braking in the combination vehicle. The computer program includes code for receiving an object detection signal from a sensor supported on a towing member of the combination vehicle. The sensor has a field of view encompassing an area on a lateral side of the combination vehicle and the object detection signal includes information regarding a location of a towed member of the combination vehicle relative to a location of the towing member of the combination vehicle. The computer program further includes code for determining, responsive to the object detection signal, whether the location of the towed member of the combination vehicle relative to a location of the towing member of the combination vehicle meets a predetermined condition. The computer program further includes code for transmitting a first control signal if the location of the towed member of the combination vehicle relative to the location of the towing member of the combination vehicle meets the predetermined condition. The first control signal is configured to cause delivery of a first fluid pressure having a first characteristic for use in actuating a service brake on the combination vehicle. The computer program further includes code for transmitting a second control signal if the location of the towed member of the combination vehicle relative to the location of the towing member of the combination vehicle does not meet the predetermined condition. The second control signal is configured to cause delivery of a second fluid pressure having a second characteristic different than the first characteristic for use in actuating the service brake.

An embodiment of a method for controlling service braking in a combination vehicle includes receiving an object detection signal from a sensor supported on a towing member of the combination vehicle. The sensor has a field of view encompassing an area on a lateral side of the combination vehicle and the object detection signal includes information regarding a location of a towed member of the combination vehicle relative to a location of the towing member of the combination vehicle. The method further includes determining, responsive to the object detection signal, whether the location of the towed member of the combination vehicle relative to a location of the towing member of the combination vehicle meets a predetermined condition. The method further includes transmitting a first control signal if the location of the towed member of the combination vehicle relative to the location of the towing member of the combination vehicle meets the predetermined condition. The first control signal is configured to cause delivery of a first fluid pressure having a first characteristic for use in actuating a service brake on the combination vehicle. The method further includes transmitting a second control signal if the location of the towed member of the combination vehicle relative to the location of the towing member of the combination vehicle does not meet the predetermined condition. The second control signal is configured to cause delivery of a second fluid pressure having a second characteristic different than the first characteristic for use in actuating the service brake.

A system and method for controlling service braking in a combination vehicle in accordance with the teachings disclosed herein is advantageous relative to conventional systems and methods. In particular, various embodiments of the system and method disclosed herein adjust braking of the vehicle commanded by ADAS systems on the vehicle to account for vehicle stability thereby increasing the safety of the vehicle operator and other individuals near the vehicle and reducing the risk of damage to the vehicle, other vehicles and road infrastructure.

The foregoing and other aspects, features, details, utilities, and advantages of the present teachings will be apparent from reading the following description and claims, and from reviewing the accompanying drawings.

### BRIEF DESCRIPTION OF THE DRAWINGS

FIG. 1 is a diagrammatic view of a combination vehicle including a system for controlling service braking in the combination vehicle in accordance with the teachings set forth herein.

FIG. 2 is a top view of the combination vehicle of FIG. 1 illustrating articulation of the members of the combination vehicle.

FIG. 3 is a diagrammatic view of a system for controlling service braking in a combination vehicle in accordance with the teachings set forth herein.

FIG. 4 is a flow chart diagram illustrating several steps in one embodiment of a method for controlling service braking in a combination vehicle in accordance with the teachings set forth herein.

### DETAILED DESCRIPTION OF THE INVENTION

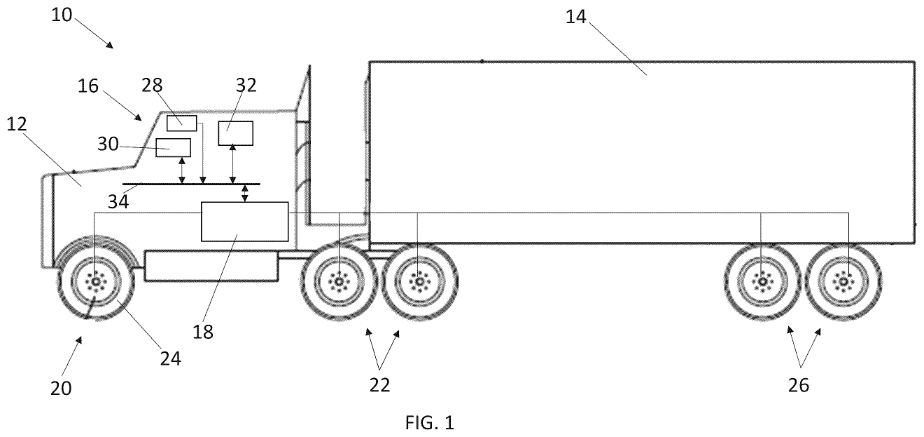

Referring now to the drawings wherein like reference numerals are used to identify identical components in the various views, FIG. 1 illustrates a combination vehicle 10. In the illustrated embodiment, vehicle 10 comprises a commercial vehicle and, in particular, a tractor-trailer. It should be understood, however, that the systems and methods disclosed herein may find application on other types of commercial and non-commercial combination vehicles. Vehicle 10 includes a towing member such as a tactor 12 and one or more towed members such as semi-trailer 14. Vehicle 10 further includes one or more advanced driver assistance systems (ADAS) 16 and a brake control system 18 for controlling service braking in combination vehicle 10 in accordance with the teachings set forth herein.

Tractor 12 provides power for moving semi-trailer 14. Tractor 12 includes steering and drive axles 20, 22 each of which support one or more wheels 24 at either end. Tractor 12 further includes a power unit, such as an internal combustion engine or electric motor for generating mechanical energy used to rotate the wheels and a battery that provides electrical energy for use in starting the power unit and, in embodiments where the power unit includes an electric motor, for use by the power unit in generating the mechanical energy used to drive the wheels. The battery may also provide power to various accessory systems on vehicle 10

Semi-trailer 14 is provided to carry or store freight and is detachably coupled to tractor 12. Although a single semi-trailer 14 is shown in the illustrated embodiment, it should be understood that the number of semi-trailers attached to tractor 12 may vary. Semi-trailer 14 is supported on one or more trailer axles 26, each of which may support one or more wheels 24 at either end.

ADAS systems 16 are provided to assist the operator of vehicle 10 by providing information (e.g., warnings) to the operator and/or assuming control of, or supplementing operator control of, various vehicle systems. ADAS systems 16 may, for example, include forward collision warning systems, blind-spot warning systems, lane departure warning systems, cross traffic warning systems, automated emergency braking (AEB) systems, anti-lock braking (ABS) systems, collision avoidance systems, adaptive cruise control systems, traction control systems, stability control systems, lane keep assist systems or lane centering systems and parking assist systems. An ADAS system 16 may include one or more sensors 28, an operator interface 30 and a controller 32. Sensors 28, operator interface 30 and controller 32 may communicate with one another through direct electrical connections or over a conventional vehicle communications bus 34 implementing a communications network such as a controller area network (CAN) or local interconnect network (LIN) or over a vehicle power line through power line communication (PLC) in accordance with various industry standard protocols including by not limited to SAE J1939, SAEJ1922, and SAE J2497 or using a proprietary protocol.

Sensors 28 are provided to identify various conditions associated with vehicle 10 and the surrounding environment including conditions that may impact the operation of vehicle 10. Sensors 28 may, for example, include speed sensors configured to determine the rotational speed of a component of vehicle 10 such as a wheel (i.e., a wheel speed sensor) or a power transmission shaft. Sensors 28 may include pressure sensors configured to determine atmospheric pressure or the pressure in a component of vehicle 10 such as tire, a brake actuator chamber, a compressor, or a conduit of a fluid circuit that delivers fluid to, or exhausts fluid from, another component of vehicle 10. Sensors 28 may include position sensors configured to determine a degree of rotation of a component of vehicle 10 such as a steering column component indicative of the steer angle for vehicle 10 (i.e., a steer angle sensor) or to determine the state or position of a component of vehicle 10 such as a brake pedal or door. Sensors 28 may include temperature sensors configured to determine ambient temperature in the area in which vehicle 10 is located or a localized temperature within vehicle 10. Sensors 28 may include moisture sensors configured to determine humidity. Sensors 28 may include altimeters configured to determine the altitude of vehicle 10 or the change in grade of the surface on which vehicle 10 is travelling. Sensors 28 may include GPS sensors or yaw rate sensors configured to determine the direction of travel of vehicle 10. Sensors 28 may also include voltage or current sensors configured to measure the voltage or current level in component of vehicle 10. Sensors 28 may also include radar (radio detection and ranging) sensors, lidar (light detection and ranging) sensors, or cameras configured to output signals indicative of the presence of objects (e.g., other vehicles, pedestrians or road infrastructure) within a defined field of view and to provide information regarding the objects including, for example, the presence of the object within the field of view, the position or location of the object within the field of view and the distance between the object and vehicle 10. It should be understood that this listing of types of sensors 28 and the operating conditions measured or sensed by the sensors 28 is not meant to be exhaustive and that other types of sensors 28 could be employed for use within ADAS system 16.

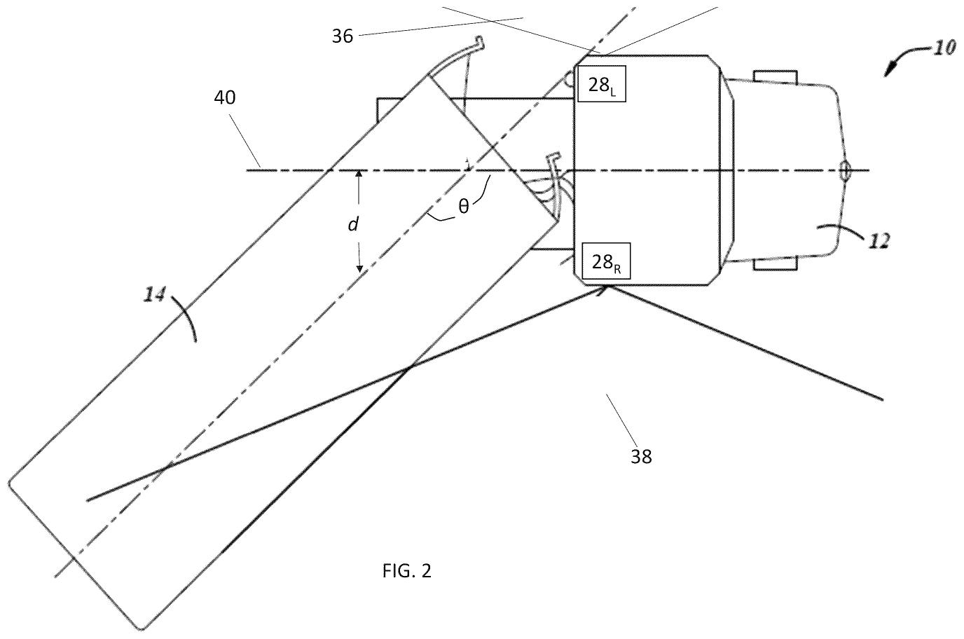

Referring now to FIG. 2, in accordance with one aspect of the systems and methods disclosed herein, sensors 28 may include radar sensors, lidar sensors, or cameras 281, and 28R supported on tractor 12 and having fields of view 36, 38 encompassing areas on each lateral side of vehicle 10. Sensors 28L, 28R may, for example, form part of an ADAS system 16 functioning as a blind-spot warning system. Sensors 281, 28R generate objection detection signals including information regarding the presence of objects within the fields of view 36, 38, the position or location of the objects within the fields of view 36, 38 and the distance between the objects and vehicle 10. In accordance with one aspect of the systems and methods disclosed herein, the object may comprise semi-trailer 14 and the object detection signals include information regarding the location of semi-trailer 14 within the fields of view 36, 38 of sensor 281, 28R. The information in the object detection signals generated by sensors 281, 28R may be used to determine, for example, an articulation angle θ between tractor 12 and semi-trailer 14 or a lateral displacement d of semi-trailer 14 from a center longitudinal axis 40 of vehicle 10 as discussed in greater detail below.

Referring again to FIG. 1, operator interface 30 provides an interface between the vehicle operator and ADAS system 16 through which the operator can control certain vehicle functions and receive information about the operation of vehicle 10. Interface 30 may be mounted within the cabin of vehicle 10 and, in particular, on the dashboard of vehicle 10. Interface 30 may assume various forms. Interface 30 may, for example, include a touch screen display with a graphical user interface (GUI). Interface 30 may include one or more handles, push buttons or switches through which an operator may input commands to vehicle 10. Interface 30 may also include light emitters, such as light emitting diodes, sound emitters, such as a speaker, and/or haptic actuators to output visual, audio and/or haptic messages (e.g., warnings or alerts) to the vehicle operator. In the case of visual messages, different information can be conveyed through differences in color, differences in intensity, differences in the number of lights, and differences in the pattern of activation of the lights. In the case of audio messages, different information can be conveyed through differences in the type of sound generated, differences in volume and differences in the pattern of sounds. In the case of haptic messages, different information can be conveyed through differences in the length, intensity, or pattern of vibration.

Controller 32 determines whether warnings and/or assistance to the operator of vehicle 10 are required and, when required, generates control signals to provide the warnings and/or assistance. Controller 32 may comprise a programmable microprocessor or microcontroller or may comprise application specific integrated circuits (ASIC). Controller 32 may include a memory and a central processing unit (CPU). Controller 32 may also include an input/output (I/O) interface including a plurality of input/output pins or terminals through which the controller 32 may receive a plurality of input signals and transmit a plurality of output signals. The controller 32 may, for example, receive input signals from sensors 28, operator interface 30, and other systems on vehicle 10 such as brake control system 18. Controller 32 may, for example, transmit output signals to operator interface 30 or other control systems on vehicle 10 such as brake control system 18. In accordance with certain embodiments of on the systems and methods disclosed herein, controllers 32 for one or more ADAS systems 16 may be configured to transmit brake request signals to brake control system 18 to request actuation of brakes on vehicle 10.

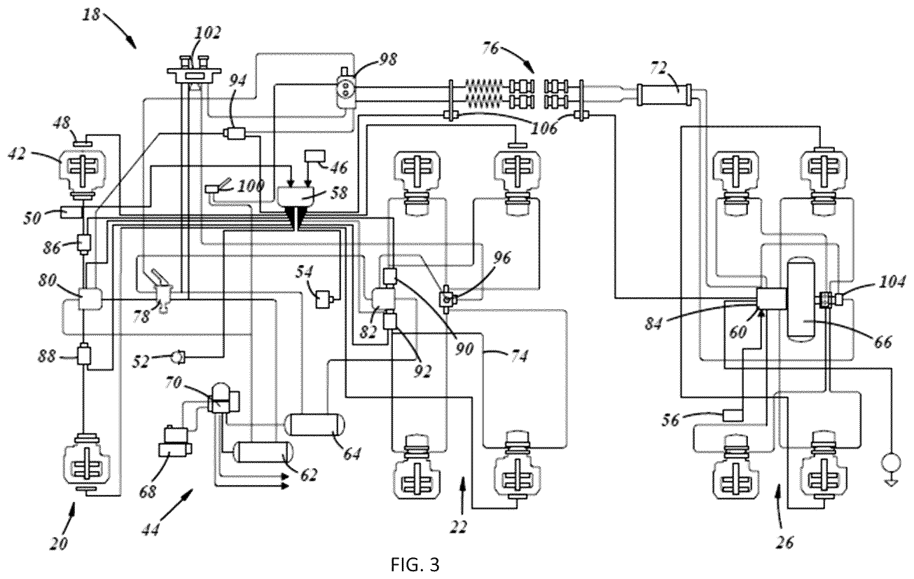

Brake control system 18 is provided to brake wheels 24 on tractor 12 and semi-trailer 14 in order to slow or stop movement of vehicle 10. System 18 may include components on both tractor 12 and semi-trailer 14 that may be in fluid and/or electrical communication using conventional connectors between tractor 12 and semi-trailer 14. In accordance with the systems and methods disclosed herein, brake control system 18 may communicate with ADAS systems 16 over communications bus 34. In particular, brake control system 18 may be configured to brake wheels 24 in response to a brake request signal generated by controller 32 of ADAS system 16 whenever controller 32 determines that automated emergency braking is required based on signals generated by sensors 28 in ADAS system 16. Referring now to FIG. 3, brake control system 18 may include wheel brakes 42, a fluid circuit 44 that supplies fluid pressure to wheel brakes 42, sensors that identify various conditions associated with vehicle 10 and the surrounding environment and that impact braking of vehicle 10 including vehicle speed sensors such as an engine or transmission speed sensor 46 and wheel speed sensors 48, pressure sensors 50, a steer angle sensor 52, a yaw rate sensor 54, and load sensors 56, and one or more controllers 58, 60.

Wheel brakes 42 are configured to apply a braking force to one or more wheels 24 on vehicle 10. Wheel brakes 42 are located at each end of steer axle 20, drive axles 22 and trailer axles 26. In the illustrated embodiment, wheel brakes 42 comprise disc brakes in which a carrier supports brake pads on opposite sides of a rotor rotating with the wheel 24 and an actuator causes, responsive to fluid pressure delivered by fluid circuit 44, movement of a caliper relative to the carrier to move the brake pads into and out of engagement with the rotor. Alternatively, one or more of wheel brakes 42 may comprise drum brakes in which an actuator such as a cam or piston causes, responsive to fluid pressure delivered by fluid circuit 44, movement of one or more brake shoes into engagement with a braking surface in a brake drum rotating with wheel 24. Wheel brakes 42 may be configured to function as both a service brake for applying service braking while the vehicle is an active state and as a parking brake for applying parking or emergency braking while the vehicle is an active or inactive state. To enable functionality as a service brake, the brake actuator for wheel brake 42 may include a member (e.g., a pushrod connected to a diaphragm) that is moved in one direction responsive to the presence of fluid pressure to move the wheel brake 42 to an applied state and in the opposite direction responsive to the absence of fluid pressure to move the wheel brake 42 to a released state. To enable functionality as a parking brake, the brake actuator for wheel brake 42 may include a spring that biases the wheel brake 42 to an applied state. Fluid pressure provided to the brake actuator is used to overcome the force of the spring and move the wheel brake 42 to a released state.

Fluid circuit 44 generates fluid pressure within brake control system 18 and controls the delivery of fluid pressure to the actuator of each wheel brake 42 to apply or release either or both of a service brake and a parking brake depending on the configuration of the wheel brake 42. Circuit 44 may include components for generating and storing pressurized fluid including fluid sources 62, 64, 66, a compressor 68, and air treatment modules 70, 72 and components for routing and delivering fluid pressure to wheel brakes 42 including fluid conduits 74, glad-hand connectors 76 between tractor 12 and semi-trailer 14, and various devices for controlling the flow of fluid within circuit 44 including a foot brake module 78, electropneumatic valve modules 80, 82, 84, modulator valves 86, 88, 90, 92, 94, a quick release valve 96, a tractor protection valve 98, a trailer control valve 100, a dash control valve 102 and a trailer parking control valve 104.

Fluid sources 62, 64, 66 store compressed fluid for use in applying wheel brakes 42. Fluid sources 62, 64 supply pressurized fluid to the wheel brakes 42 for steer axle 20 and drive axles 22. Fluid source 62 has fluid ports coupled to air treatment module 70, foot brake module 78, electropneumatic valve module 80 and trailer control valve 100. Fluid source 64 has fluid ports coupled to air treatment module 70, foot brake module 78 and electropneumatic valve module 82. Fluid source 64 supplies pressurized fluid to the wheel brakes 42 for trailer axles 26. Fluid source 64 has fluid ports coupled to electropneumatic valve module 84 and trailer parking control valve 104.

Compressor 68 draws in air and compresses the air for delivery to fluid sources 62, 64 through air treatment module 70. Compressor 68 has one or more fluid ports coupled to air treatment module 70.

Air treatment modules 70, 72 are provided to collect and remove solid, liquid and vapor contaminants from pressurized fluid. Air treatment module 70 is disposed between compressor 68 and fluid sources 62, 64 and has fluid ports coupled to compressor 68 and each fluid source 62, 64. Air treatment module 72 is supported on semi-trailer 14 between glad-hand connectors 76 and electropneumatic valve module 84 and has fluid ports coupled to glad-hand connectors 76 and electropneumatic valve module 84. Air treatment module 72 assists in removing contaminants from the fluid in situations where tractor 12 lacks an air treatment module and/or when semi-trailer 14 becomes disconnected from tractor 12.

Fluid conduits 74 are used to transport fluid between fluid sources 62, 64, 66 compressor 68, air treatment modules 70, 72, glad-hand connectors 76, foot brake module 78, electropneumatic valve modules 80, 82, 84, modulator valves 86, 88, 90, 92, 94 quick release valve 96, tractor protection valve 98, trailer control valve 100, dash control valve 102 and trailer parking control valve 104 and wheel brakes 42. Conduits 74 may be made from conventional metals and/or plastics and have connectors at either end configured to join the conduits 74 to corresponding components of fluid circuit 44.

Glad-hand connectors 76 are used to transmit pressurized fluid from tractor 12 to semi-trailer 14. One of connectors 76 is used to transmit supply/emergency fluid pressure during emergency braking while the other connector 76 is used to transmit service/control fluid pressure during service braking.

Foot brake module 78 provides an interface through which a vehicle operator may input a command to apply wheel brakes 42 and control the delivery of fluid pressure to wheel brakes 42 for service braking. Foot brake module 78 is supported within the cabin of tractor 12 and includes a brake pedal that may be actuated by the operator. Actuation of the brake pedal opens a valving member in foot brake module 78 that allows fluid pressure from fluid sources 62, 64 to flow to electropneumatic valve modules 80, 82 and tractor protection valve 98. Foot valve module 78 therefore has fluid ports in communication with fluid sources 62, 64, electropneumatic valve modules 80, 82 and tractor protection valve 98. It should be understood that foot brake module 78 includes one example of an operator-controlled valve for service braking, but that other types of operator-controlled valves for service braking may be used in addition to, or as an alternative to, the valve in foot brake module 78.

Electropneumatic valve modules 80, 82, 84 are provided to control delivery of fluid pressure to wheel brakes 42 on steer axle 20, drive axles 22 and trailer axles 26, respectively, for use in controlling the application and release of service brakes in wheel brakes 42. Module 80 may define a single fluid channel configured to deliver the same fluid pressure to wheel brakes 42 on either end of steer axle 20. Modules 82, 84 may define a pair of fluid channels permitting delivery of varying fluid pressure to the wheel brakes on either end of drive axles 22 and trailer axles 26 for use in stability control. Modules 80, 82, 84 include one or more relay valves that deliver fluid pressure from a fluid source 62, 64, 66 to wheel brakes 42 or exhausts fluid pressure from wheel brakes 42 responsive to a control pressure (from, for example, foot brake module 78). The relay valves increase the volume of fluid, and therefore the flow, at which fluid is delivered to, and exhausted from, wheel brakes 42 in order to reduce lag times between the commanded and actual application and release of wheel brakes 42. Modules 80, 82, 84 further include solenoid valves configured to regulate the control pressure from foot brake module 78 and, therefore, control the operation of the relay valve. An electronic control unit in each module 80, 82, 84 controls the operation of the solenoid valves responsive to control signals from one of controllers 58, 60. The electronic control unit may also process signals from pressure sensors within modules 80, 82, 84 and from wheel speed sensors 48 and brake lining wear sensors associated with corresponding wheels and wheel brakes 42, respectively, and may generate and transmit signals indicative of fluid pressure, wheel speed and brake lining wear to any of controllers 58, 60. Modules 80, 82, 84 may transmit signals to and/or receive signals from controllers 58, 60 indirectly over bus 34 or, alternatively, through dedicated electrical connections with controllers 58, 60. Electropneumatic valve module 80 has a fluid supply port in communication with fluid source 62 and fluid delivery ports in fluid communication with foot pedal module 78 and modulator valves 86, 88, 94 through which module 80 delivers fluid pressure for use in actuating wheel brakes 42 on axle 20. Electropneumatic valve module valve 82 has a fluid supply port in communication with fluid source 64 and fluid delivery ports in communication with foot pedal module 78, modulator valves 90, 92 through which module 82 delivers fluid pressure for use in actuating wheel brakes on axles 22, and quick release valve 98. Electropneumatic valve module valve 84 has a fluid supply port in communication with air treatment module 72 and fluid delivery ports in communication with trailer parking control valve 104 and each wheel brake 42 on trailer axles 26 for use in actuating wheel brakes 42 on trailer axles 26. Electropneumatic valve module valve 84 may be integrated with a modulator valve and controller 60 in some embodiments. Electropneumatic valve modules 80, 82, 84 may operate under the control of controllers 58, 60 to implement anti-lock braking/traction control when required.

Modulator valves 86, 88, 90, 92, 94 are provided to implement an anti-lock braking function. During normal braking, valves 86, 88, 90, 92, 94 allow fluid pressure to pass from electropneumatic valve modules 80, 82 to wheel brakes 42 without interference. During a loss of traction, however, signals from controller 58 causes modulator valves 86, 88, 90, 92, 94 to modulate the fluid pressure to prevent lockup of the wheels 24. Modulator valves 86, 88 have fluid ports coupled to electropneumatic valve module 80 and to wheel brakes 42 on steer axle 20. Modulator valves 90, 92 have fluid ports coupled to electropneumatic valve module 82 and to wheel brakes 42 on drive axle 22. Finally, modulator valve 94 has fluid ports in communication with electropneumatic valve module 80 and tractor protection valve 98.

Quick release valve 96 transmits fluid pressure from dash control valve 102 to the brake actuators for the wheel brakes 42 on drive axles 22 and exhausts fluid from wheel brakes 42 in the absence of fluid pressure from dash control valve 102 to release and apply parking brakes in wheel brakes 42 on drive axles 22. Valve 96 has a supply port in fluid communication with a delivery port on dash control valve 102 and delivery ports in fluid communication with the brake actuators for the wheel brakes 42 on drive axles 22. Valve 96 further has a balance port in fluid communication with electropneumatic valve module 82 to prevent compounding during service braking.

Tractor protection valve 98 transmits pneumatic signals relating to operation of the wheel brakes 42 on semi-trailer 14 from tractor 12 to semi-trailer 14 including control pressures to control the service brakes in wheel brakes 42 of semi-trailer 14. Valve 98 also protects the fluid supply for tractor 12 in the event of a brake in the fluid connection between tractor 12 and semi-trailer 14. Valve 98 has fluid ports in communication with foot pedal module 78, modulator valve 94, trailer control valve 100, dash control valve 102, and glad-hand connectors 76.

Trailer control valve 100 allows the vehicle operator to control wheel brakes 42 on semi-trailer 14 independent of the wheel brakes 42 on tractor 12. Valve 100 may be mounted within the cabin of tractor 12 and permits delivery of fluid directly from fluid source 62 to tractor protection valve 98 for delivery to wheel brakes 42 in semi-trailer 14. Valve 100 has fluid ports in communication with fluid source 62 and tractor protection valve 98.

Dash control valve 102 allows the vehicle operator to implement several functions including releasing parking brakes on tractor 12 or semi-trailer 14 by supplying fluid pressure to oppose spring forces in the actuators for wheel brakes 42. Valve 102 has fluid ports in communication with fluid sources 62, 64, quick release valve 96 and tractor protection valve 98.

Trailer parking control valve 104 is provided to control the parking or emergency braking function of the actuators for the wheel brakes 42 on semi-trailer 14. Valve 104 is mounted directly to fluid source 66. Valve 104 has fluid ports in communication with fluid source 66, air treatment module 72 and wheel brakes 42 on semi-trailer 14.

Engine or transmission speed sensor 46 generates a signal indicative of the speed of vehicle 10. Sensor 46 may comprise one or more magnets configured to track the rotation of a driveshaft or similar component in the drivetrain for tractor 12 and generate signals indicative of the speed of rotation. A controller, such as controller 58 can then determine the speed of vehicle 10 responsive to the signal.

Wheel speed sensors 48 generate signals indicative of the rotational speed of a corresponding wheel 24. Each sensor 48 may include a magnet surrounded by a coil disposed proximate to a toothed ring on a wheel 24. Rotation of the toothed ring causes changes in the direction and intensity of the magnetic fields and is indicative of rotation of the wheel 24. Controllers 58, 60 can determine the rotational speed of each wheel 24 responsive to signals generated by sensors 48. Based on the rotational speed of wheels 24, controllers 58, 60 can determine whether certain wheels 24 are slipping and implement anti-lock braking through control of electropneumatic valve modules 80, 82, 84 and modulator valves 86, 88, 90, 92, 94. Controllers 58, 60 can also determine the speed of vehicle 10 responsive to the determined speed of wheels 24.

Pressure sensors 50 generate signals indicative of the fluid pressure at various locations within fluid circuit 44. Although only one pressure sensor 50 is illustrated in FIG. 2, it should be understood that pressure sensors 50 may be located through fluid circuit 44.

Steer angle sensor 52 outputs a signal indicative of a steering angle imparted by a vehicle operator to a steering wheel in tractor 12. Sensor 52 may be mounted on a steering column within tractor 12.

Yaw rate sensor 54 generates a signal indicative of the angular velocity of tractor 12 about its vertical (yaw) axis. An electronic stability control system may compare the output of sensors 52, 54 to determine whether the intended direction of travel for vehicle 10 (as indicated by sensor 52) matches the actual direction of travel (as indicated by sensor 54) and thereby determine whether there has been a loss of traction between the wheels 24 and the road. When the intended and actual directions of vehicle 10 diverge, the system generates control signals for one or both of the vehicle engine and the wheel brakes 42 in order to control the torque at one or more of the wheels 24 so that the actual direction of vehicle 10 will match the intended direction.

Load sensor 56 generates a signal indicative of the forces at a given location. Load sensor 56 may be used to determine the load on one or more of trailer axles 26 in order to assist in determining the stability of semi-trailer 14. Load sensor 56 may comprise a strain gauge, piezoelectric sensor or a fluid (hydraulic or pneumatic) sensor.

Controllers 58, 60 control the operation of electropneumatic valve modules 80, 82, 84 and modulator valves 86, 88, 90, 92, 94 in order to control the fluid pressure delivered to wheel brakes 42 and, therefore, the braking force applied to wheels 24. Controllers 58, 60 may comprise programmable microprocessors or microcontrollers or may comprise application specific integrated circuits (ASICs). Each controller 58, 60 may include a memory and a central processing unit (CPU). Each controller 58, 60 may also include an input/output (I/O) interface including a plurality of input/output pins or terminals through which the controller 58, 60 may receive a plurality of input signals and transmit a plurality of output signals. The input signals may include signals received from controller 32 in ADAS system 16 and from sensors 46, 48, 50, 52, 54, 56. In accordance with one aspect of the systems and methods disclosed herein, the input signals may also include signals from sensors 281, and 28R. The output signals may include signals used to control electropneumatic valve modules 80, 82, 84 and modulator valves 86, 88, 90, 92, 94. In the illustrated embodiment, tractor 12 and semi-trailer 14 include separate controllers 58, 60 that may communicate with one another across an electrical connector 106 between tractor 12 and semi-trailer 14. It should be understood, however, that the functionality of controllers 58, 60 could be combined into a single controller or further sub-divided among multiple sub-controllers.

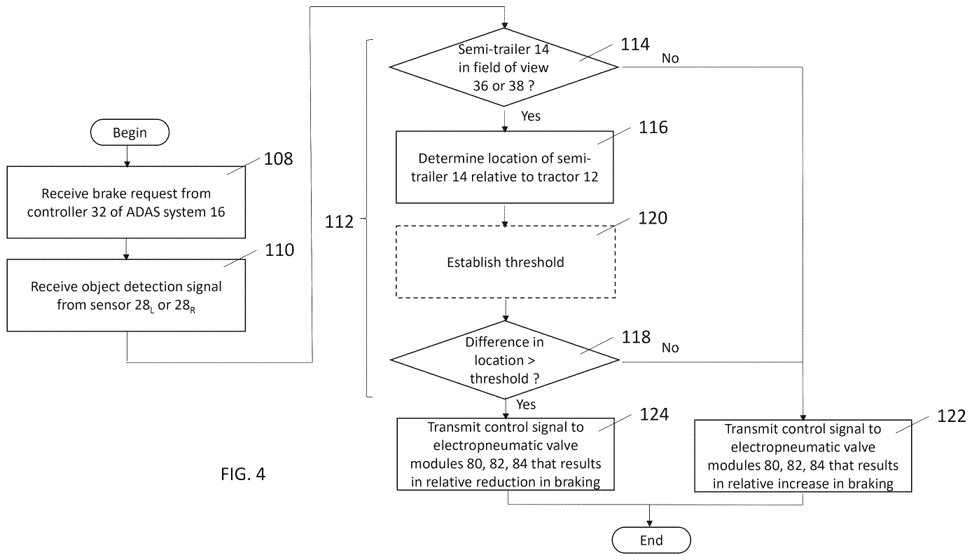

In accordance with the present teachings, one or more of controllers 32, 58, 60 may be configured with appropriate programming instructions (i.e., software or a computer program) to implement several steps in a method for controlling service braking in vehicle 10 as described below. The instructions or computer program may be encoded on a non-transitory computer storage medium such as a memory within, or accessible by, controllers 32, 58, 60. Referring now to FIG. 4, in embodiments in which controller 32 does not directly control electropneumatic valve modules 80, 82, 84, the method may begin with the step 108 of controller 58 and/or 60 receiving a brake request signal from a controller 32 for an ADAS system 16 on vehicle 10. As discussed hereinabove, controllers 32 for one or more ADAS systems 16 may be configured to transmit brake request signals to brake control system 18 to request actuation of brakes on vehicle 10. For example, automated emergency braking (AEB) systems, collision avoidance systems, and adaptive cruise control systems are some of the ADAS systems 16 that are configured to generate and transmit signals to brake control system 18 to request actuation of the wheel brakes 42 on vehicle 10. In other embodiments, controller 32 may directly control electropneumatic valve modules 80, 82, 84.

The method may continue with the step 110 of receiving an object detection signal from one of sensors 28L, 28R including information regarding the location of semi-trailer 14 relative to the field of view 36, 38 of the sensor 28L, 28R and relative to the location of tractor 12 As discussed hereinabove and with reference to FIG. 2, sensors 28L, 28R each have a field of view 36, 38 on opposite lateral sides of vehicle 10. As semi-trailer 14 moves away from the center longitudinal axis 40 of vehicle 10 (either intentionally as the result of the steering of vehicle 10 or unintentionally due to a loss of stability), semi-trailer 14 will enter the field of view 36, 38 of one of sensors 28L, 28R. The object detection signals generated by sensors 281, 28R will therefore provide information on the presence of semi-trailer 14 within the field of view 36, 38 and the location of semi-trailer 14 relative to the field of view 36, 38 and relative to the location of tractor 12.

The method may continue with the step 112 of determining, responsive to the object detection signal, whether the location of the semi-trailer 14 relative to the location of tractor 12 meets a predetermined condition. Step 112 may include several substeps 114, 116, 118, 120. In substep 114, controllers 32, 58, 60 may determine whether semi-trailer 14 is present within the field of view 36, 38 of sensors 281, 28R. Controllers 32, 58, 60 may be configured to identify semi-trailer 14 in a conventional manner by identifying, in the case of radar or lidar sensors, signatures in radar or lidar data indicative of semi-trailer 14 or, in the case of cameras, identifiable elements (e.g., an axle 26) of semi-trailer 14 in images. If controllers 32, 58, 60 determine that semi-trailer 14 is not present in the field of view 36, 38 of sensors 28L, 28R, the method may proceed directly to step 122 described hereinbelow. If controllers 32, 58, 60 determine that semi-trailer 14 is present in the field of view 36, 38 of sensors 281, 28R, the method may continue with substep 116 in which controllers 32, 58, 60 determine the location of semi-trailer 14 relative to the location of tractor 12. In one embodiment, the relative location between tractor 12 and semi-trailer 14 comprises an articulation angle θ between tractor 12 and semi-trailer 14. In another embodiment, the relative location between tractor 12 and semi-trailer 14 comprises a lateral displacement d of semi-trailer 14 from center longitudinal axis 40 of tractor 12. The articulation angle θ or lateral displacement d can be determined in a conventional manner responsive to the position of semi-trailer 14 within the field of view 36, 38. In substep 118, controllers 32, 58, 60 compare the relative location of tractor 12 and semi-trailer 14 to a threshold value. Again, in one embodiment the threshold value corresponds to a predetermined articulation angle between tractor 12 and semi-trailer 14. In another embodiment, threshold value corresponds to a predetermined lateral displacement of semi-trailer 14 from axis 40 of tractor 12. In some embodiments, the threshold values may be static values stored in a memory of controllers 32, 58, 60 or an external memory accessible by controllers 32, 58, 60. In another embodiment, the threshold values may be dynamic values. In one embodiment, for example, controllers 32, 58, 60 may, in a substep 120 prior to substep 118, establish the threshold value responsive to a predicted path of travel of vehicle 10 as indicated by, for example, steer angle sensor 52. In particular, controllers 32, 58, 60 may establish a threshold value for the articulation angle θ between tractor 12 and semi-trailer 14 or the lateral displacement d of semi-trailer 14 relative to axis 40 that is greater than the articulation angle θ or lateral displacement d that would be expected to result from the commanded steering of the vehicle 10 by the vehicle operator. For example, controllers 32, 58, 60 may compute the threshold by adding a predetermined offset to the articulation angle θ or lateral displacement d that would be expected to result from the commanded steering of the vehicle 10 or by using a formula based on the articulation angle θ or lateral displacement d that would be expected to result from the commanded steering of the vehicle 10.

In substep 120, controllers 32, 58, 60 determine whether the relative location of tractor 12 and semi-trailer 14 meets a predetermined condition relative to the threshold value (e.g., is greater than, is greater than or equal to, or is within a defined range or offset relative to the threshold value). For example, if the articulation angle θ between tractor 12 and semi-trailer 14 is greater than a threshold value for the articulation angle, controllers 32, 58, 60 may determine that vehicle 10 is unstable. Similarly, if the lateral displacement d of semi-trailer 14 relative to axis 40 is greater than a threshold value for the lateral displacement, controllers 32, 58, 60 may determine that vehicle 10 is unstable.

If controllers 32, 58, 60 determine that the location of semi-trailer 14 relative to the location of tractor 12 does not meets the predetermined condition (e.g., is less than or is not within a defined range or offset relative to the threshold value), the method may continue with the step 122 of transmitting a control signal to one or more of electropneumatic valve modules 80, 82, 84 that is configured to cause the electropneumatic valve module 80, 82, 84 to deliver a fluid pressure having a first characteristic. In embodiments in which controller 32 does not directly control electropneumatic valve modules 80, 82, 84, controllers 58, 60 may transmit the control signal, responsive to a brake request signal from controller 32. The characteristic may, for example, relate to the level of fluid pressure or the duty cycle at which the fluid pressure is provided. Because controllers 32, 58, 60 have determined that vehicle 10 is stable, the fluid pressure may be provided at a relatively high level or may have a duty cycle in which fluid pressure is provided for relatively long periods of time to allow for increased braking capability while vehicle 10 is stable.

If controllers 32, 58, 60 determine that the location of semi-trailer 14 relative to the location of tractor 12 meets the predetermined condition (e.g., is greater than, greater than or equal to, outside of a defined range or offset relative to the threshold value), the method may continue with the step 124 of transmitting a control signal to one or more of electropneumatic valve modules 80, 82, 84 that is configured to cause the electropneumatic valve module 80, 82, 84 to deliver a fluid pressure having a second characteristic, different than the first characteristic. Again, in embodiments in which controller 32 does not directly control electropneumatic valve modules 80, 82, 84, controllers 58, 60 may transmit the control signal, responsive to a brake request signal from controller 32. Because controllers 32, 58, 60 have determined that vehicle 10 is unstable, the fluid pressure may be provided at a relatively low level or may have a duty cycle in which fluid pressure is provided for relatively short periods of time to reduce braking while vehicle 10 is unstable.

A system 18 and method for controlling service braking in a combination vehicle 10 in accordance with the teachings disclosed herein is advantageous relative to conventional systems and methods. In particular, various embodiments of the system 18 and method disclosed herein adjust braking of the vehicle 10 commanded by ADAS systems 16 on the vehicle 10 to account for vehicle stability thereby increasing the safety of the vehicle operator and other individuals near the vehicle 10 and reducing the risk of damage to the vehicle 10, other vehicles and road infrastructure.

While the invention has been shown and described with reference to one or more particular embodiments thereof, it will be understood by those of skill in the art that various changes and modifications can be made without departing from the spirit and scope of the invention.

What is claimed is:

1. A system for controlling service braking in a combination vehicle, comprising:
a controller configured to
receive an object detection signal from a sensor supported on a towing member of the combination vehicle, the sensor having a field of view encompassing an area on a lateral side of the combination vehicle and the object detection signal including information regarding a location of a towed member of the combination vehicle relative to a location of the towing member of the combination vehicle;
determine, responsive to the object detection signal, whether the location of the towed member of the combination vehicle relative to the location of the towing member of the combination vehicle meets a predetermined condition;
transmit a first control signal if the location of the towed member of the combination vehicle relative to the location of the towing member of the combination vehicle meets the predetermined condition, the first control signal configured to cause delivery of a first fluid pressure having a first characteristic for use in actuating a service brake on the combination vehicle; and,
transmit a second control signal if the location of the towed member of the combination vehicle relative to the location of the towing member of the combination vehicle does not meet the predetermined condition, the second control signal configured to cause delivery of a second fluid pressure having a second characteristic different than the first characteristic for use in actuating the service brake.

2. The system of claim 1 wherein the controller comprises a brake controller and the brake controller is further configured to receive a brake request signal from an advanced driver assistance system controller on the combination vehicle and to transmit one of the first and second control signals responsive to the brake request signal.

3. The system of claim 1 wherein the controller is further configured, in determining, responsive to the object detection signal, whether the location of the towed member of the combination vehicle relative to the location of the towing member of the combination vehicle meets a predetermined condition, to compare the location of the towed member of the combination vehicle relative to the location of the towing member of the combination vehicle to a threshold value.

4. The system of claim 3 wherein the threshold value corresponds to a predetermined articulation angle between the towing member and the towed member.

5. The system of claim 3 wherein the threshold value corresponds to a predetermined lateral displacement of the towed member from a center longitudinal axis of the towing member.

6. The system of claim 3 wherein the controller is further configured to establish the threshold value responsive to a predicted path of travel of the combination vehicle.

7. The system of claim 1 wherein the first characteristic comprises a first level and the second characteristics comprises a second level different than the first level.

8. The system of claim 1 wherein the first characteristic comprises a first duty cycle and the second characteristic comprises a second duty cycle different than the first duty cycle.

9. An article of manufacture, comprising:
a non-transitory computer storage medium having a computer program encoded thereon that, when executed by a controller on a combination vehicle controls service braking in the combination vehicle, the computer program including code for:
receiving an object detection signal from a sensor supported on a towing member of the combination vehicle, the sensor having a field of view encompassing an area on a lateral side of the combination vehicle and the object detection signal including information regarding a location of a towed member of the combination vehicle relative to a location of the towing member of the combination vehicle;
determining, responsive to the object detection signal, whether the location of the towed member of the combination vehicle relative to a location of the towing member of the combination vehicle meets a predetermined condition;
transmitting a first control signal if the location of the towed member of the combination vehicle relative to the location of the towing member of the combination vehicle meets the predetermined condition, the first control signal configured to cause delivery of a first fluid pressure having a first characteristic for use in actuating a service brake on the combination vehicle; and,
transmitting a second control signal if the location of the towed member of the combination vehicle relative to the location of the towing member of the combination vehicle does not meet the predetermined condition, the second control signal configured to cause delivery of a second fluid pressure having a second characteristic different than the first characteristic for use in actuating the service brake.

10. The article of manufacture of claim 9 wherein the code for determining, responsive to the object detection signal, whether the location of the towed member of the combination vehicle relative to the location of the towing member of the combination vehicle meets a predetermined condition, includes code for comparing the location of the towed member of the combination vehicle relative to the location of the towing member of the combination vehicle to a threshold value.

11. The article of manufacture of claim 10 wherein the threshold value corresponds to a predetermined articulation angle between the towing member and the towed member.

12. The article of manufacture of claim 10 wherein the threshold value corresponds to a predetermined lateral displacement of the towed member from a center longitudinal axis of the towing member.

13. The article of manufacture of claim 10 wherein the computer program further includes code for establishing the threshold value responsive to a predicted path of travel of the combination vehicle.

14. The article of manufacture of claim 9 wherein the first characteristic comprises a first level and the second characteristics comprises a second level different than the first level.

15. The article of manufacture of claim 9 wherein the first characteristic comprises a first duty cycle and the second characteristic comprises a second duty cycle different than the first duty cycle.

16. A method for controlling service braking in the combination vehicle, comprising:
receiving an object detection signal from a sensor supported on a towing member of the combination vehicle, the sensor having a field of view encompassing an area on a lateral side of the combination vehicle and the object detection signal including information regarding a location of a towed member of the combination vehicle relative to a location of the towing member of the combination vehicle;
determining, responsive to the object detection signal, whether the location of the towed member of the combination vehicle relative to a location of the towing member of the combination vehicle meets a predetermined condition;
transmitting a first control signal if the location of the towed member of the combination vehicle relative to the location of the towing member of the combination vehicle meets the predetermined condition, the first control signal configured to cause delivery of a first fluid pressure having a first characteristic for use in actuating a service brake on the combination vehicle; and,
transmitting a second control signal if the location of the towed member of the combination vehicle relative to the location of the towing member of the combination vehicle does not meet the predetermined condition, the second control signal configured to cause delivery of a second fluid pressure having a second characteristic different than the first characteristic for use in actuating the service brake.

17. The method of claim 16 wherein determining, responsive to the object detection signal, whether the location of the towed member of the combination vehicle relative to the location of the towing member of the combination vehicle meets a predetermined condition, includes comparing the location of the towed member of the combination vehicle relative to the location of the towing member of the combination vehicle to a threshold value.

18. The method of claim 17 wherein the threshold value corresponds to a predetermined articulation angle between the towing member and the towed member.

19. The method of claim 17 wherein the threshold value corresponds to a predetermined lateral displacement of the towed member from a center longitudinal axis of the towing member.

20. The method of claim 17 further including establishing the threshold value responsive to a predicted path of travel of the combination vehicle.
